(19) United States
(12) Patent Application Publication
(10) Pub. No.: US 2002/0059116 A1
(43) Pub. Date: May 16, 2002

(54) Method and system for selectively displaying advertisements on a display device

(76) Inventors: Marija V. Bulatovic, Skokie, IL (US); Jeffrey F. Kurgan, Hoffman Estates, IL (US)

Correspondence Address: BANNER & WITCOFF, LTD., TEN SOUTH WACKER DRIVE, SUITE 3000, CHICAGO, IL, 60606, US

(21) Appl. No.: 09/918,841

(22) Filed: Jul. 31, 2001

Related U.S. Application Data
(60) Provisional application No. 60/221,816, filed on Jul. 31, 2000.

(51) Int. Cl. G06F 17/60

(52) U.S. Cl. 705/27; 709/217

(57) ABSTRACT

Disclosed are techniques for receiving and selectively displaying information on a display device. Specifically, a display device retrieves requested information and advertising over a network. When the user displays requested information, the display device executes an algorithm to display advertising summary information that is targeted to the requested information being displayed. If the user seeks to view more information regarding the advertisement, the complete advertisement may thereby be displayed.

### RELATED APPLICATION

This application claims priority to provisional patent application No. 60/221,816, filed Jul. 31, 2000.

### FIELD OF THE INVENTION

The present invention relates to techniques for receiving and selectively displaying information on a display device. More specifically, the invention relates to a method and apparatus for sending advertisement information over a network to a display device for selectively displaying and reading at a later time. The invention provides for the sending of information during low traffic periods on the network to a display device and for displaying selective information at a later time.

### BACKGROUND OF THE INVENTION

Known advertising distribution systems utilize various media to deliver advertisements to potential consumers. Common methods include print advertisements consisting of newspaper, magazine and billboard advertisements as well as electronic means such as television and radio advertisements. More recently, advertisers are utilizing the Internet, also known as the World Wide Web (www), as a media of reaching potential consumers. These electronic advertisement means typically utilize a display device such as a television screen or sound transmissions to relay an advertisement originating from a distribution network. This network may be a television or radio station, the World Wide Web, or an intranet. Each of the above-mentioned advertising distribution systems require that both the display or sounding unit and the network are “ON” at the time of delivery of advertising information. For example, a consumer must be tuned into a television station or a radio network to receive advertising information transmitted via these distribution systems. In the event that one of these elements is not being turned “ON”, the distribution channel breaks down, and the transmitted information is no longer available to the consumer.

Due to the high costs of advertising, many advertisers and marketers prefer to target specific customers while they are on the network. For example, manufacturers of sporting equipment and magazines often advertise during televised sporting events. Likewise, toy manufacturers prefer to advertise during Saturday morning cartoons and after school television programs. One disadvantage of targeted advertising is the increased costs and demand associated with advertising during specific times of the day, evening or during special programming such as the National Football League's Super Bowl. Also, the practice of targeted advertising eliminates large segments of time and opportunity to convey their advertising message throughout the day or night. This may diminish a company's efforts to successfully administer effective, targeted advertising strategies.

U.S. Pat. No. 5,809,242 entitled “Electronic Mail System for Displaying Advertisement at Local Computer Received from Remote System While the Local Computer is Off-Line the Remote System” discloses a system for providing scheduled messages to a remote user in a batch oriented system. In particular, while the user is preparing or viewing an e-mail, a message is displayed on the user's screen. The advertisement may be targeted to the user based on the user's profile. This patent, however, requires the user to provide a user profile, which often raises privacy concerns for the user. Moreover, the information is displayed only while the user is working in an e-mail application. Finally, since the information is merely based on the user's profile, the display of the information may not be timely with what the user is doing at any given time. For example, even though the user's profile shows that the user is interested in sports, he/she may not be interested in viewing sports information while the he/she is working.

Other disadvantages with prior art systems is that the flexibility and scope of numbers of targeted customers that can be reached via advertising campaigns is inhibited by the immobility of either device or network. Also, in a network system, both components must be “ON” for the information to be delivered to the potential consumer. Also, given the large of targeted and non-targeted channels on networks (cable or satellite television stations, internet sites and radio stations) compete against non-targeted channels to reach the greatest number of potential consumers while they are tuned into the network. As such, customization of advertising information towards a specific consumer becomes difficult.

Another disadvantage of advertising distribution systems is the costs of the equipment placed on the consumer. For example, consumers must have access to a television set, cable or satellite systems, personal computers and the Internet via an Internet service provider (ISP) to view these advertisements. If these costs to the potential consumer are too great, companies who advertise using targeted methods may actually limit the number of potential consumers who will be exposed to their advertising and marketing information. Covering costs of the display device and network service charges is costly to consumers, and may, in fact, inhibit distribution and dissemination of advertising information.

It would be advantageous to both customers and advertisers to have an advertising distribution channel, which is free of charge and does not include upfront purchases of devices. Moreover, a system that does not require monthly contracts and provides allows for greater mobility, independent of the network is desired. Such an improvement would allow for more prolific distribution of advertising and information of higher quality that is more precisely targeted to a specific audience.

An advertising distribution system that provides advertising information to the consumer and independent of the network being “ON” is desired. Furthermore, a system that does not require the purchase of special devices and service for delivering advertising information is also desired. This type of advertising system would grant greater mobility to potential consumers, as well as the ability for advertisers to reach a targeted audience when and where the consumer choose throughout the day.

### SUMMARY OF THE INVENTION

The present invention provides an advertising distribution system having improved scope and mobility and selectively targets advertisements to the interests of the user. Advertisements are set from a network to the user via a display device. The user may view the targeted advertisements while disconnected from the network and the advertisement information may be transmitted from the network to the user during low traffic periods to reduce costs and prevent delays in receiving the information. The present invention is functionally independent of the network, and has embedded magnetic media memory stored in the unit itself. This stored magnetic memory provides greater mobility of device and provides greater flexibility when consumers and advertisers are “ON” the network.

The advertising system is comprised of an electronic device, with an advertising displaying apparatus that includes an external data receiver for connecting with a network. In the case of a device that includes wireless capability, the external data receiver may not be required. The connection may be with a wireless network via a cellular phone or cellular modem or a connector port for a wired network. Additionally, the electronic display device utilizes a storage device and a memory reader. Advertisements advertising are transmitted from a network to the electronic display device and stored in the storage device. An algorithm is provided on the electronic display device that selectively chooses from the advertising information stored in the electronic display device based upon the actions of the user and is displayed to the device. The network can either be a wireless, wired, or physical, non-electronic network.

The electronic device utilizes memory for storage of advertisement information. The advertisement information is selectively displayed to the user over an extended period of time without connecting to the network thereby avoiding network service charges from an ISP or cable service provider. The method provided instructs the electronic device to connect to the network via a traditional telephone or “land line” or through a cellular modem or telephone. More particularly, advertising information is transmitted from the network to the electronic display device and is stored in memory of the device. Once the user interacts with the electronic display device, an internal algorithm monitors the actions of the user and selectively recalls stored advertisement information from memory and displays the information to the user. In one preferred embodiment, the algorithm identifies the information that the user is viewing with the electronic display device and, by utilizing a keywords index, identifies which advertising information from memory to display to the user. The user thereby views advertising information that is targeted to the user based on the user's interests and based upon what the user is viewing on the display device at a particular moment.

When the electronic device reconnects to the network, new advertising information may replace the previously stored information; however, unviewed advertisements may be kept in memory for later displaying. The provided method monitors which advertisements have been viewed by the user and may selectively eliminate stored advertisement information that is not of interest to the user based upon the users past viewing habits.

In another aspect, the present method provides for the periodical transfer of advertising information during off-peak times, during typically low traffic times such as during the late evening or early morning hours of the network, to decrease the time and/or the bandwidth cost to the user on the network. The provided method reduces the connection time to the network during the downloading period of advertising information.

### BRIEF DESCRIPTION OF THE DRAWINGS

FIG. 1 is a schematic diagram representing a basic form of a advertisement information distribution system;

FIG. 2 is a block diagram representing the advertisement information distribution system when used with a personal digital assistant;

FIG. 3 is a block diagram of the advertisement information distribution system as used with a radio device;

FIG. 4 is a block diagram representing the advertisement information distribution system utilizing a CD ROM and a personal computer;

FIG. 5 is a schematic diagram representing an electronic display device connected to a network containing multiple servers and an information database;

FIG. 6 is a block diagram of the information database showing a keyword index, information summary and information for sending over the network; and

FIG. 7 is a diagram illustrating a user interacting with the electronic display device, triggering the keyword index, recalling from a memory location an information summary and displaying the information to the user.

FIG. 8 is a flow chart illustrating the overall steps performed in the method for receiving and selectively displaying information on a display device in accordance with a preferred embodiment of the present invention.

### DETAILED DESCRIPTION OF THE PREFERRED EMBODIMENTS

The present invention provides a method and system for receiving and selectively displaying information on a display device. In a preferred embodiment, the present invention is utilized in conjunction with a handheld computing device, such as a Personal Digital Assistant (PDA), for delivering and displaying advertising information that is targeted to the user's interests and the information that the user is viewing at any given time. Although not required, the invention will be described in the general context of computer-executable instructions, such as program modules. Generally, program modules include routines, programs, objects, scripts, components, data structures, and the like that perform particular tasks or implement particular abstract data types. The present invention provides for a software system that may be implemented on any network infrastructure. In a distributed computing environment, program modules may be located in both local and remote memory storage devices.

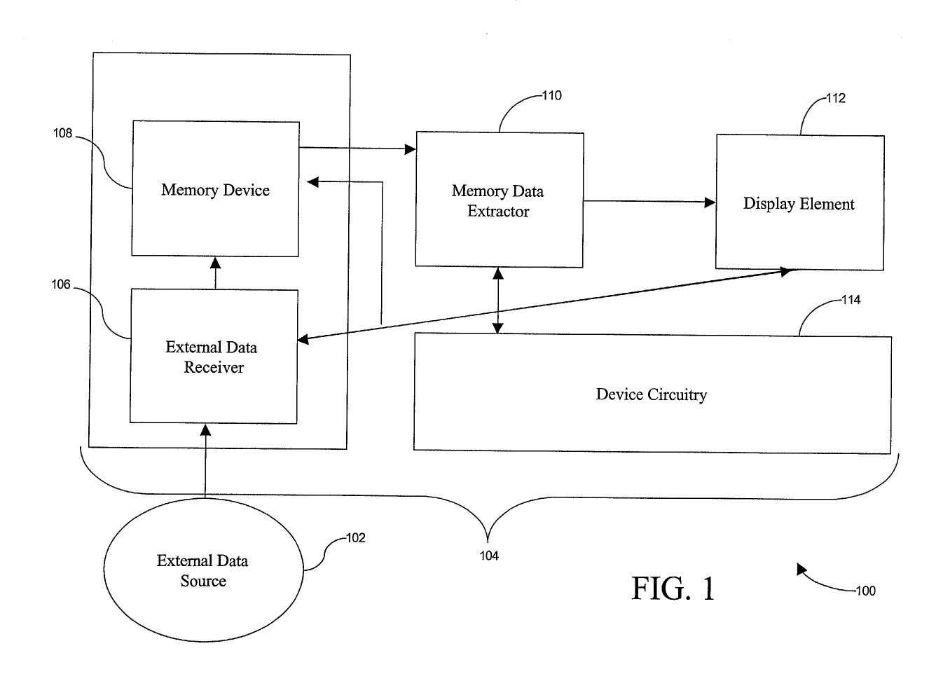

FIG. 1 and the following discussion are intended to provide a brief general description of a suitable computing environment in which the invention may be implemented. Various elements of the system of the present invention may implement some or all the features and components of the computing environment of FIG. 1. For example, as illustrated herein, clients or devices may take on the form of a general-purpose computer or may be a simplified version of the same such as a computing device. Referring to the drawings, FIG. 1 is a schematic diagram representing the generic components of an advertisement information distribution system 100 that connects to a network. The network supplies data to advertisement information distribution system 100 from an external data source 102 on the network to an electronic display device 104 (such as a PDA). Electronic display device 104 receives data from an external data receiver 106 such as a conventional telephone, cellular modem, an Internet-ready cellular telephone, a PDA with wireless capability, or similar wireless device. In the embodiment of a PDA, the electronic display device 104 receives data by way of a “sync” operation via a personal computer or via known wireless techniques. In yet another embodiment, electronic display device 104 may be a Personal Video Recorder (PVR), such at those devices sold under names TiVo and REPLAY. Electronic display device 104 also contains a memory device 108 for storing information received by external data receiver 106. Memory device 108 may consists of cache memory in the random access memory (RAM) of the device, a flash memory, and a magnetic hard drive or similar data storage device. External data or information received from external data source 102 is stored in memory device 108 and is retrieved by a memory data extractor 110. Once memory data extractor 110 has selected data stored in memory device 108, the selected data is displayed to the user by a display element 112 which may consists of video monitor, liquid crystal audio display or other screen presentation. Electronic display device 104 also contains device circuitry 114 for controlling the internal functions of the unit. The general structure and operation of electronic display devices such as PDAs are generally well-known by those skilled in the art.

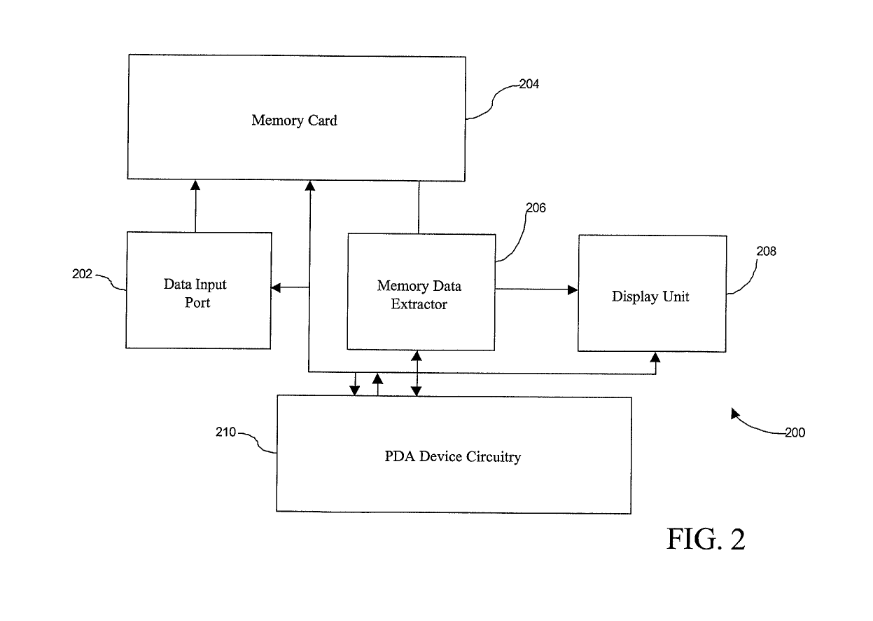

Again, electronic display device 104 may take the form of a personal digital assistant (PDA) 200. FIG. 2 is a block diagram of the components of PDA, which function as electronic display device 104. PDA 200 contains a data input port 202 for connecting to a network. Data input port 202 may take the forms such of an infrared data port, a serial or USB (universal serial bus) connect, or a wireless port. Some of these connections may interface with an external modem that connects to the network via a telephone line, cellular phone or directly with a network or interfaces with a computer that accesses the network. Moreover, data input port 202 may take the form of an internal modem, that connects to the network via a telephone line or a cellular phone. PDA 200 also contains a memory card 204 for storing information received from the network. Data card 204 may be a removable storage device or an internal storage location. Memory card 204 also interfaces and works with internal flash memory in RAM of PDA 200. A memory data extractor 206 also resides in PDA 200 for selecting information received via data input port 202. The selected information is displayed to PDA 200 user on a display unit 208. PDA 200 also contains PDA device circuitry 210 to carry out the functions of PDA 200.

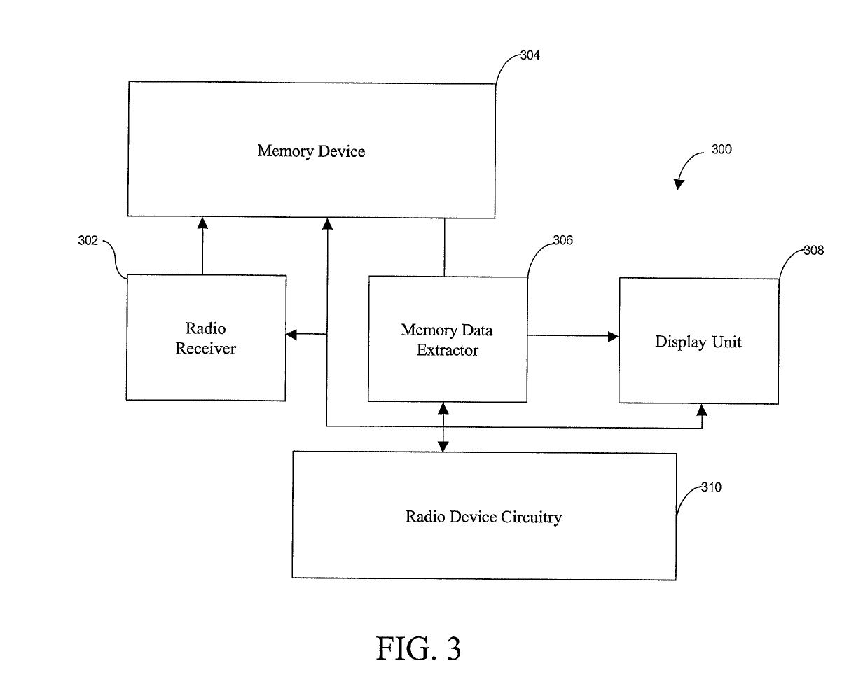

Optionally, advertisement information distribution system 100 may also utilize sound to convey the information along with a visual display. Electronic display and sound device 300 utilizes a radio receiver 302 for receiving information sent in a radio signal, as shown in FIG. 3. Radio receiver 302 receives the advertising information and stores the information in a memory device 304 such as a magnetic storage hard drive or flash memory in RAM. Electronic display and sound device 300 also contains a memory data extractor 306 that determines when advertising information stored in memory device 304 should be sent to a visual display unit 308 and the radio device circuitry 310 which may also be used to transmit a verbal or musical advertisement.

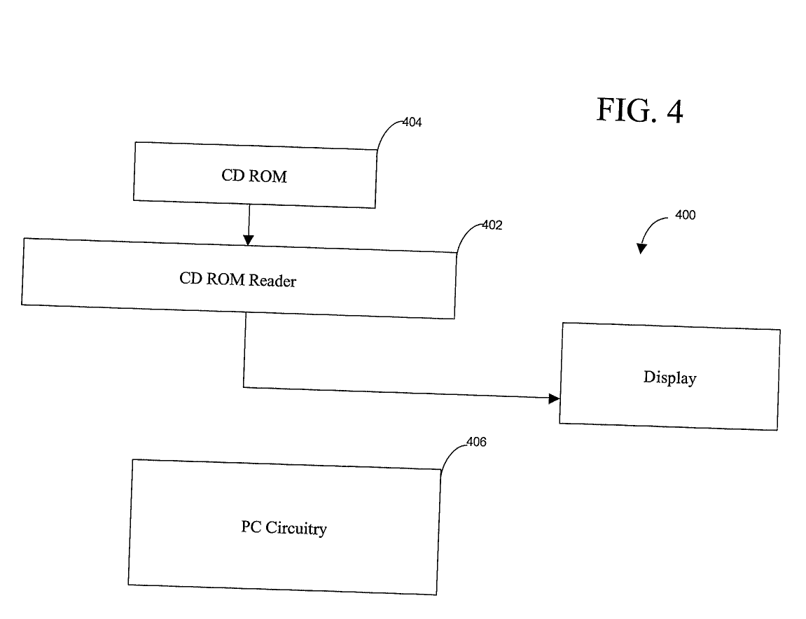

Another form of advertisement information distribution system 100 utilizes a personal computer as the electronic display device 400 as shown in FIG. 4. Due to the increased computing and storage capacity of a personal computer, electronic display device 400 can function as both PDA 200 and electronic display and sound device 300. In addition, personal computer 400 may utilize removable storage devices such as a CD ROM Reader 402 and an CD ROM (read-only memory) 404. When CD ROM 404 is utilized, the computer's circuitry (PC circuitry) 406 acts as memory data extractor 110 that recalls the advertisement information from CD ROM 404. In this type of system, the user receives a pre-recorded CD with advertisement information. This pre-recorded advertisement information can also be distributed by computer 400 to other computers through e-mail or over a network.

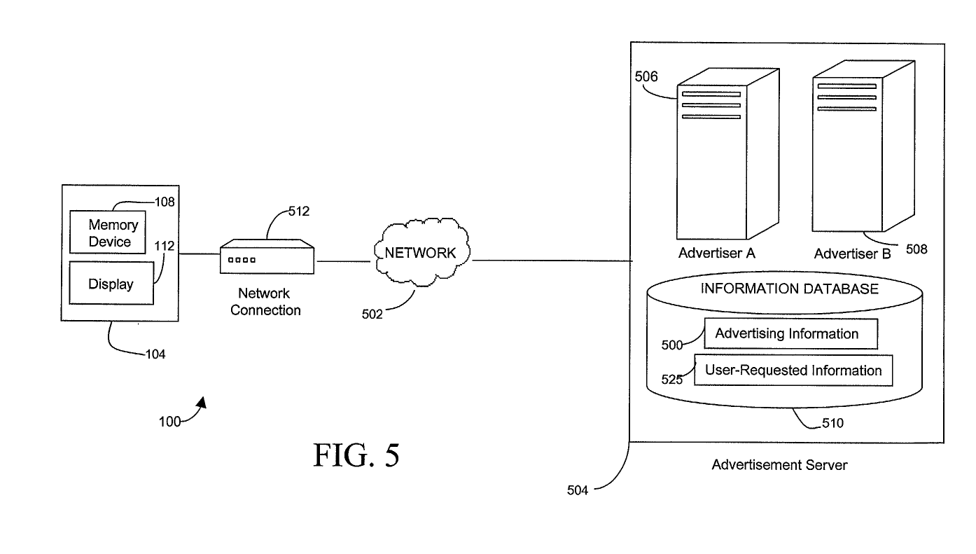

Turning to the operation of advertisement information distribution system 100, FIG. 5 illustrates how electronic display device 104 interacts with a network. Referring to both FIGS. 1 and 5, advertisement information distribution system 100 provides for the sending of advertising information 500 over a network 502 to an electronic display device 104 having a memory location 108. Network 502 may include any number of known and future networks including for example, the Internet, an intranet, an extranet, a local area network (LAN), a wide area network (WAN), or generally a client/server-based network of computers.

Advertisement information distribution system 100 utilizes a main advertisement server 504 which periodically receives advertisements from one or more advertisers, such as advertiser A 506 and advertiser B 508 as shown in FIG. 5. Advertisements sent by advertiser A 506, advertiser B 508, and others are stored in an advertisement server 504. Although not required, advertisement server 504 preferably contains known algorithms for organizing the advertisements in a form that allows for quick identification and retrieval and stores the advertisements in an information database 510.

In one embodiment, the information database 510 of the advertisement server 504 also includes user-requested information 525, namely information that an information distribution system 100 requests. For example, in the embodiment of the PDA, the user may “sync” with advertising server 504 to retrieve selected information to which the user has subscribed, commonly referred to as “channels.” Advertisement server 504 retrieves the various user requested information 525 for each channel and stores it in information database 510 for subsequent delivery to the information distribution system 100. Those skilled in the art will appreciate that the information database 510 having the advertising information 500 and user-requested information 525 may exist in separate databases at the same location or may exist in various distributed databases existing over the network 502. All such embodiments are considered to be within the scope of the present invention.

In the embodiment of FIG. 5, when requested, advertisement server 504 extracts advertising information 500 and the user-requested information 525 from information database 510 and sends them over network 502 to an electronic display device 104 through a network connection 512.

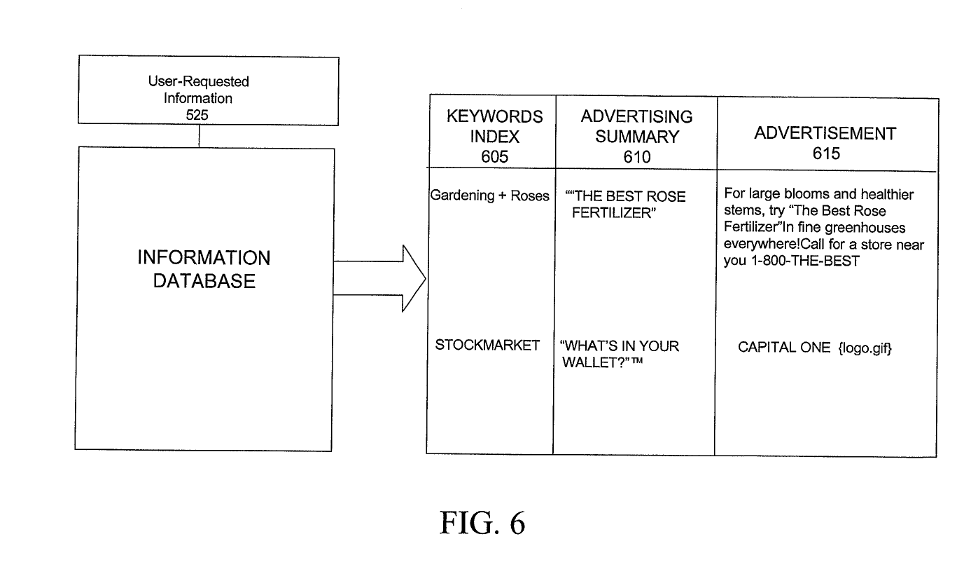

As stated, information database 510 stores the advertisements in a form that allows for quick identification and retrieval. Each advertisement is organized to have associated with it a corresponding advertising summary and a corresponding keywords index. As illustrated in FIG. 6, in accordance with a preferred embodiment of the present invention, each advertisement is graphically represented in column 615, with the corresponding advertising summary and keywords index represented in columns 610 and 605 respectively. In this embodiment, and as will be described further below, the advertisement of column 615 reflects the entire advertisement that may be displayed on the information distribution system 100. The advertising summary of column 610 reflect information that may be presented on the display of the electronic display device 104 when the user takes some action to view certain other information. The keywords index 615 of column 605 provides a look-up table to target a specific advertisement to the user of the electronic display device 104 based on the information that the user is viewing at any given moment. The advertisement of column 615 may also include an audio aspect in the embodiment of FIG. 3.

The advertising information 500 and user-directed information 525, when requested, is delivered from the advertisement server 504 to the information distribution system 100. For example, the electronic display device 104 may “sync” with the advertising server 504 to retrieve the information. During this “sync” process, the electronic display device 104 stores the advertising information 500 and user-directed information 525 in the memory device 108. The electronic display device 104 then “logs-off” or disconnects from the advertising server 504.

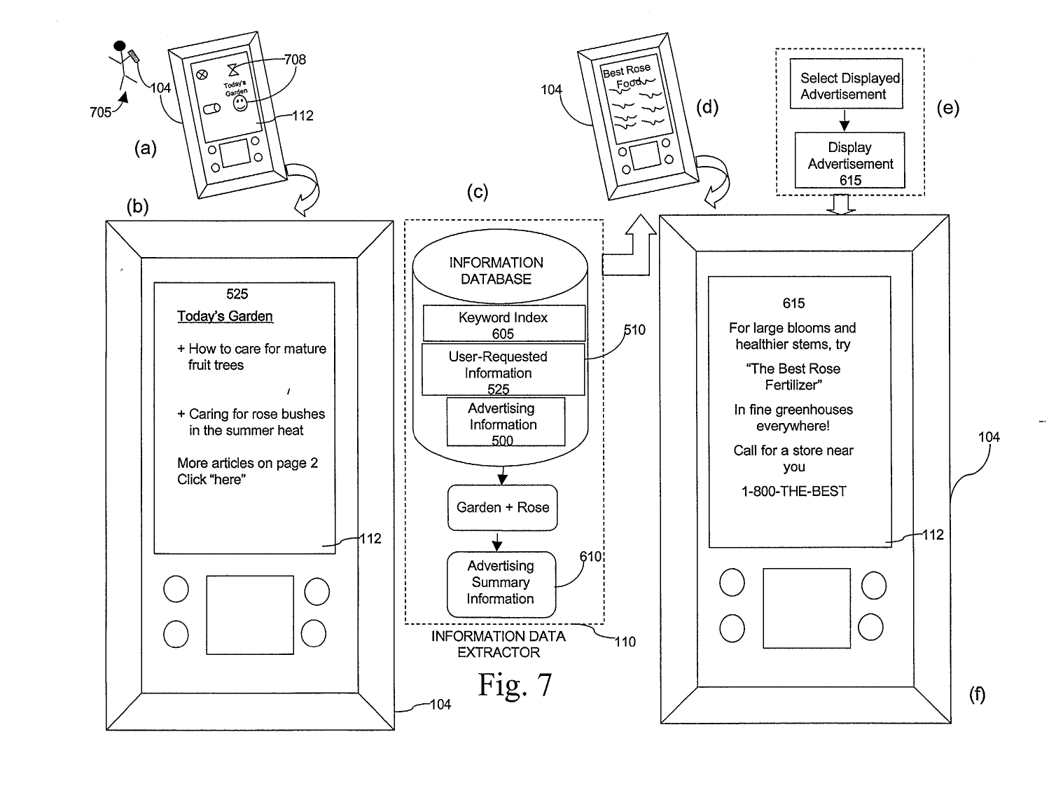

Once the retrieved information has been stored in memory of the electronic display device 104, the user may at a subsequent time access this information. As illustrated in FIG. 7(a), the user 705 may operate the electronic display device 104 to view the retrieved information stored in memory. The display element 112 of the electronic display device 104 may display the retrieved user-requested information 525 in the form of icons 708 or any other format. For example, the user-requested information 525 may be displayed according to the channels to which the user 705 has subscribed. If the user 705 wishes to view a specific portion of the user-requested information 525, he/she may do so, for example, by selecting the appropriate icon 708.

As illustrated in FIG. 7(b), the display element 112 of the electronic display device 104 may display the selected content of the user-requested information 525. In accordance with the present invention, the electronic display device 104 responsively retrieves targeted advertising information from memory for display on the display element 112. As illustrated in FIG. 7(c), the memory data extractor 110 extracts the selected user-requested information 525 for display, in this example, articles from a “Today's Garden” channel. The memory data extractor 110 thereafter identifies the targeted advertising information for display. In this regard, an algorithm is provided on the electronic display device 104 that selectively chooses from the advertising information stored therein based upon the actions of the user and displays it to user. Specifically, the memory data extractor 110 identifies the words in the displayed user-requested information 525 and correlates them with words in the keywords index 605 of the stored advertising information 500. If a word from the keywords index 605 is identified, the data extractor retrieves the corresponding advertising summary information 610 for display. If more than one word from the keywords index 605 is identified, the data extractor 110 preferably performs an algorithm to identify one advertising summary 610 for display. For example, each advertising summary 610 may have a pre-defined hierarchy, may be organized alphabetically, or may be randomly selected. In another embodiment, the data extractor 110 may retrieve more than one advertising summary 610 for display.

The advertising summary(ies) 610 may be displayed in any format including for example, without limitation, at a designated portion of the display 112 (as illustrated in FIG. 7(d)), or as an overlay over the user-requested information 525 being displayed. Advantageously, in accordance with the present invention, when a user 705 retrieves user-requested information for display, the electronic display device 104 simultaneously displays targeted advertising information that is relevant to the information to the information that the user is viewing. In the example, of FIG. 7, when the user is viewing information about “Caring for Rosebushes in the Summer Heat,” the electronic display device 104 also displays an advertisement about “The Best Rose Food.”

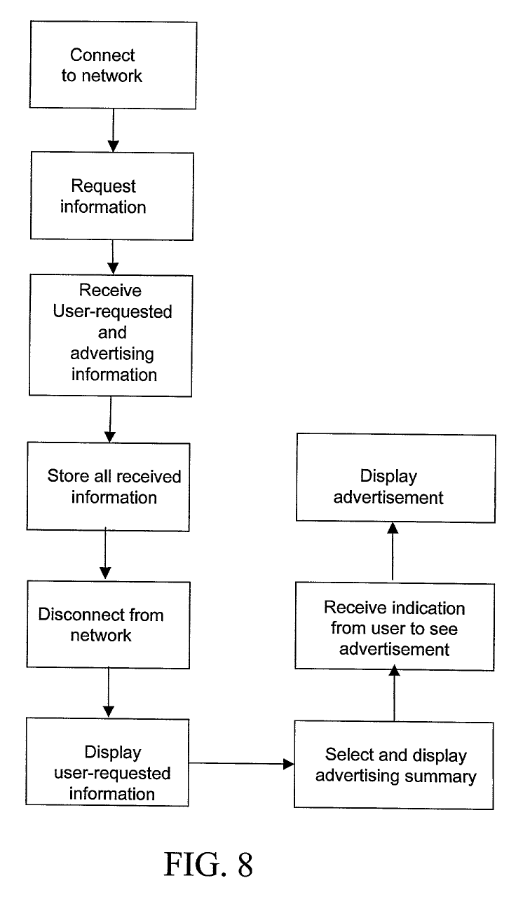

In the event that the user becomes interested in learning more about the displayed advertising summary 610, the user may provide an input to the electronic display device 104, for example, by selecting the advertising summary 610 on the display 112 using a stylus. The data extractor 110 thereby retrieves the corresponding full advertisement 615, as shown in FIG. 7(e), and displays it on the display 112, as illustrated in FIG. 7(f). The above-described process of the present invention is also illustrated in FIG. 8.

In another aspect of the present invention, the electronic display device 104 may access information from the advertisement server 504 during low traffic times such as during the late evening or early morning hours. In this regard, the electronic display device 104 may be programmed to perform its information retrieval or “sync” process at a pre-designated time when low traffic over the network 502 is likely.

In the embodiment of a PVR, the electronic display device 504 may download programming information in accordance with known techniques, but also retrieves advertising information. As part of the programming information, the PVR receives a text summary of each program. The PVR may then selectively display advertising information based on the programming that the user is watching on the television. In particular, the keywords index 605 can match advertisements to the TV program based on the text summary that is associated with the particular TV program in accordance with the above-described techniques of the present invention.

In yet another aspect of the present invention, the advertisement server 504 may pre-correlate advertising information 500 according to the user-requested information. In particular, some or all of the functionality of the data extractor 110 described above may be implemented within the advertisement server 504. Under this embodiment, only the advertising information (i.e., the advertisement 615 and the advertising summary 610) correlating to the user-requested information subscribed to by the user will be downloaded to the electronic display device 104. Under this embodiment, a lesser amount of advertising information need be retrieved, thereby reducing connect time between the electronic display device 104 and the advertisement server 504.

The invention described in the above detailed description is not intended to be limited to the specific form set forth herein, but on the contrary it is intended to cover such alternatives, modifications and equivalents as can reasonably be included in within the spirit and scope the appended claims.

We Claim:

1. A method for selectively displaying information received from a network on an electronic display device comprising the steps of:
connecting to a remote network;
requesting information from the remote network;
receiving information from the remote network;
storing the received information in a memory location;
disconnecting from the remote network; and
selectively displaying stored information while disconnected from the remote network.

2. The method of claim 1 wherein the step of receiving information from the remote network includes receiving advertising information.

3. The method of claim 2 wherein the advertising information includes a keywords index, at least one advertising summary, and at least one advertisement.

4. The method of claim 1 wherein the step of receiving information from the remote network includes receiving user-requested information.

5. The method of claim 1 wherein the step of receiving includes compiling a listing of words and an associated index for referencing the information received from the network and stored in the memory location.

6. The method of claim 1 wherein the step of selectively displaying includes the steps of:
displaying user-requested information;
performing a keywords search to identify at least one targeted advertisement;
selecting at least one targeted advertising summary; and
displaying the at least one targeted advertising summary.

7. The method of claim 6 wherein the step of selectively displaying further includes the steps of:
receiving an indication from a user to see an advertisement corresponding to the advertising summary; and
displaying the advertisement.

8. The method of claim 1 wherein the step of selectively displaying stored information while disconnected from the remote network includes monitoring actions of a user.

9. The method of claim 8 wherein the step of monitoring the actions of the user includes comparing words displayed on the electronic display device with words in a keywords index.

10. The method of claim 9 wherein the step of comparing the words displayed on the electronic display device includes recalling from a memory location information associated with the keywords index when a word displayed on the electronic display device matches a word in the keywords index.

11. The method of claim 1 wherein the step of selectively displaying stored information while disconnected from the remote network includes displaying a summary of the information on the electronic display device.

12. The method of claim 11 wherein the step of selectively displaying stored information includes choosing the summary with an input device.

13. The method of claim 12 wherein the step of choosing the summary the summary with an input device triggers the displaying of stored information from the memory location on the electronic display device.

14. A computer-readable medium having computer-executable instructions for performing the steps recited in claim 1.

15. An electronic display device for selectively displaying information received from a network comprising in combination:
means for coupling to a network and receiving information to be selectively displayed;
a memory having stored therein the received information to be selectively displayed;
a display for displaying the received information to be selectively displayed stored in memory; and
means for monitoring actions of a user to select which received information is to be displayed on the display.

16. The electronic display device of claim 15, further comprising a memory reader.

17. The electronic display device of claim 15, wherein the received information to be selectively displayed is advertising information.

18. The electronic display device of claim 15, wherein the received information to be selectively displayed includes a summary of the received information to be selectively displayed.

19. The electronic display device of claim 15, wherein the means for coupling is capable of coupling to an Internet.

20. The electronic display device of claim 15, wherein the means for coupling is capable of coupling to the network via a wireless connection.

21. The electronic display device of claim 15, wherein the memory also has stored therein a keywords index and the means for monitoring utilizes the keywords index to select the information to be displayed.

22. A server capable of coupling to an electronic display device via a network comprising in combination:
means for coupling to the electronic display device via a network;
means for providing information to be selectively displayed on the electronic display device; and
means for providing a keywords index to the electronic display device to allow the electronic display device to select the which information is to be displayed on the electronic display device based on actions of a user.

23. A method in a server for providing advertising information to an electronic display device for selective display thereon comprising the steps of:
receiving a request for information from an electronic display device via a network;
providing advertising information to the electronic display device for storage therein; and
providing a keywords index to the electronic display device to allow the electronic display device selectively display the advertising information based on actions of a user.

24. A method in a server for providing advertising information to an electronic display device for selective display thereon comprising the steps of:
receiving a request for information from an electronic display device via a network;
comparing words in the requested information with words in a keywords index to identify targeted advertising information; and
providing the requested information for display on the electronic display device; and
providing the identified targeted advertising information also for display on the electronic display device.

25. A method in an electronic display device for displaying targeted advertising information to a user comprising the steps of
receiving an indication from a user to display information stored in memory;
displaying on the display device the information in accordance with the user indication;
identifying at least one targeted advertisement stored in memory based on the user indication; and
displaying on the display device the targeted advertisement.

26. The method of claim 25 wherein the step of identifying includes the step of using a keywords index to correlate at least one word from the information with at least one targeted advertisement.

27. The method of claim 25 wherein the step of displaying the targeted advertisement includes the step of displaying a summary of the targeted advertisement.

28. The method of claim 27, further comprising the steps of:
receiving an indication from a user to display additional details of the displayed targeted advertisement; and
displaying on the display the additional details of the displayed targeted advertisement.

29. A computer-readable medium having computer-executable instructions for selectively displaying information received from a network on an electronic display device comprising the steps of:
connecting to a remote network;
requesting information from the remote network;
receiving information from the remote network;
receiving a keywords index from the remote network and compiling a listing of words and an associated index for referencing the information received from the network and stored in the memory location;
storing the received information in a memory location;
disconnecting from the remote network;
monitoring actions of a user
comparing words displayed on the electronic display device with words in a keywords index by recalling from a memory location information associated with the keywords index when a word displayed on the electronic display device matches a word in the keywords index; and
selectively displaying stored information while disconnected from the remote network.

30. The method of claim 29 wherein the step of selectively displaying stored information while disconnected from the remote network includes displaying a summary of the information on the electronic display device.

31. The method of claim 30 wherein the step of selectively displaying stored information includes choosing the summary with an input device.

32. The method of claim 31 wherein the step of choosing the summary the summary with an input device triggers the displaying of stored information from the memory location on the electronic display device.

33. An advertising display apparatus for displaying advertising indicia in human perceptible form at an electronic device, said advertising display apparatus comprising:
an external data receiver coupled to receive indications representative of data to be displayed;
a memory device coupled to said external data receiver, said memory device including storage locations at which to store the indications representative of the data;
a memory data extractor coupled to said memory device, said memory data extractor selectively operable to extract the data stored at said memory device; and
a display device coupled to said memory data extractor, said display device for displaying in human perceptible form the data selectively extracted by said memory data extractor.

34. The advertising display apparatus of claim 33 wherein said external data receiver comprises a connector port connectable to receive the indications of the data.

35. The advertising display apparatus of claim 33 wherein the indications of the data to be displayed are embodied at magnetic media, and wherein said external data receiver comprises a magnetic media reader coupled to receiver, and to read, magnetic media.

36. The advertising display apparatus of claim 33 wherein said external data receiver comprises a radio receiver for receiving radio signals, the radio signals including the indications of the data.

37. A method for displaying advertising indicia in human perceptible form at an electronic device, said method comprising:
providing indications of data representative of the advertising indicia to be displayed to the electronic device;
storing the indications provided during said operation of providing at a memory device;
selectively extracting the indications stored at the memory device; and displaying the indications at a display device in human perceptible form.
